(19) United States
(12) Patent Application Publication
(10) Pub. No.: US 2024/0166881 A1
(43) Pub. Date: May 23, 2024

(54) EMULSIFYING COMPOSITION FOR BITUMEN

(71) Applicant: VALOCHEM, SATHONAY-CAMP (FR)

(72) Inventor: Guillaume ROUSSEAU, PAU (FR)

(21) Appl. No.: 18/282,567

(22) PCT Filed: Mar. 21, 2022
(86) PCT No.: PCT/FR2022/050507

§ 371 Date: Sep. 18, 2023

(30) Foreign Application Priority Data
Mar. 22, 2021 (FR) FR2102819

(51) Int. Cl. C08L 95/00

(52) U.S. Cl. CPC C08L 95/005; C08L 2555/40

(57) ABSTRACT

The present disclosure relates to an emulsifier composition comprising:
a copolymer comprising between 10 mol % and 70 mol % of at least one monomeric unit A and between 30 mol % and 90 mol % of at least one monomeric unit B, the said monomeric unit B being cationic or cationizable at acid pH,
and at least one emulsifier chosen from the group comprising cationic emulsifiers, non-ionic emulsifiers and amphoteric emulsifiers, and mixtures thereof.

### TECHNICAL AREA

The present disclosure relates to the field of polymeric emulsifiers. In particular, the present disclosure relates to emulsifying compositions for bitumens incorporating at least one polymeric emulsifier, in particular for the preparation of bituminous road materials. More specifically, the present disclosure belongs to the fields of maintenance and upkeep of road networks with Asphalt Concrete with Bitumen Emulsion (ACBE), according to the definition given in point 3.1.9 of standard NF EN 13108-31 of September 2019.

### BACKGROUND ART

There are several techniques for preparing bituminous road materials. They fall into three main categories: so-called cold techniques, so-called hot techniques and so-called warm techniques.

So-called cold techniques allow the use of the binder and aggregates at temperatures below 100° C., usually at room temperature. They are based on the use of bitumen emulsions as binder. Bitumen is then dispersed in an aqueous phase by mechanical action in the presence of surfactants.

So-called hot techniques use an anhydrous binder which is made, or kept, fluid by heating, generally to 160° C. or more. Hot techniques employ aggregates that are heated and dried at high temperature before being brought into contact with the binder. For example, asphalt mix can be produced at a temperature of around 160° C., or higher depending on the characteristics of the binder, by coating the aggregates with the binder. This is known as hot mix asphalt.

So-called warm techniques make it also possible to carry out the operations described above, but at lower temperatures than those used for hot techniques, generally between 100° C. and 150° C. These are known as warm mixes. Some so-called warm techniques can be carried out in the presence of water with a mass percentage of less than 3% relative to the mass of bitumen. In these techniques, the components are dry before the addition of water.

Bitumen emulsions are obtained by hot dispersion of a bituminous binder in an aqueous phase. The manufacture of such emulsions requires both mechanical shear energy and chemical energy. The latter is necessary in order to reduce the water/bitumen surface tension and to enable mid-term conservation of the bitumen in its dispersed state in the aqueous phase, i.e. approximately 1 month. This chemical energy is provided by so-called surface-active molecules and its intensity therefore depends on the family of molecules under consideration.

Techniques using bitumen emulsions, in particular so-called cold techniques, can be used for various applications such as:
coating, such as “gravel emulsions”, “microsurfacing” (ECF), “cold dense asphalt” and “storable asphalt”;
spreading, like “surface dressing”, “seal coat”, “impregnation emulsions” and “tack coats”;
sprayed asphalt also known as “jet patching”.

These three types of road application use bitumen emulsions with characteristics adapted to the intended application. It is known to those skilled in the art that to obtain a bitumen emulsion suitable for cold mix technique, and more precisely a “gravel emulsion”, a slow-breaking emulsion is required so that it can diffuse into the granular matrix during the coating phase. It is also necessary that the emulsion is storage stable in order to prevent breakage in storage or transport tanks, and is sufficiently adhesive to meet the performance criteria for these materials. As a general rule, emulsions that meet these criteria are of the C60B5/B7 and/or C65B5/B7 type. These designations, taken from standard NF EN 13808, define cationic emulsions with a medium to slow breaking time. pH of these emulsions is less than or equal to 7. The emulsifiers generally employed in these coating techniques are cationic surfactants of the polyamine, polyamidoamine or imidazopolyamine type. Amphoteric surfactants are also used in these applications.

Solutions for improving the adhesion between bituminous binder and aggregates have been proposed, among which the use of the reaction product of a styrene-maleic anhydride polymer with a polyalkylene amine in anionic bituminous emulsions disclosed in U.S. Pat. No. 5,776,234. Anionic emulsions differ from cationic emulsions due to their breaking mechanism. In fact, the vast majority of bituminous emulsions for road applications are cationic. Anionic bitumen emulsions are mainly used for industrial applications, such as building waterproofing, for example for foundations or sub-bases.

There is a need to propose, for road applications, a new family of surface-active molecules and a new surface-active composition with the objective to obtain bitumen emulsions, in particular cationic bitumen emulsions, with a good binder content, a small sieve non-passing fraction, a breaking speed suited to the intended application and good storage stability, a breaking speed adapted to the intended application and good storage stability, and whose use in cold coating techniques, for example gravel emulsion, makes it possible to obtain materials which have good coating quality, good storability, good workability and improved water resistance.

Existing technologies can achieve one or more of the four criteria described above, but never all four at the same time. For example, fatty amines give good water resistance, but a coating of less than 80%; amine-modified lignin based cationics give a coating of 100%, but generally a water resistance below the standard.

In particular, the present invention aims to improve the water resistance, while maintaining or improving the coating ratio, of materials obtained from a bitumen emulsion and to better control the breakage kinetics. It should be noted that the breaking kinetics is linked to the evaporation and drying kinetics when anionic emulsifying compositions are used, but linked to the chemical reaction kinetics when cationic emulsifying compositions are employed.

### SUMMARY

This present disclosure improves the situation.

An emulsifier composition is proposed comprising:
a copolymer comprising between 10 mol % and 70 mol % of at least one monomeric unit A and between 30 mol % and 90 mol % of at least one monomeric unit B, said monomeric unit B being cationic or cationizable at acid pH,
and at least one emulsifier chosen from the group comprising cationic emulsifiers, nonionic emulsifiers and amphoteric emulsifiers and mixtures thereof.

According to another aspect, it is proposed a bituminous emulsion comprising a bituminous binder, the emulsifying composition as described above, and water, characterized in that the percentage by weight of the copolymer of the said emulsifying composition, relative to the total weight of the emulsion, is between 0.75% and 3%, more advantageously between 0.9% and 2% and even more advantageously between 1% and 1.4%.

According to another aspect, it is proposed to use a copolymer of formula I, in salified form or not:

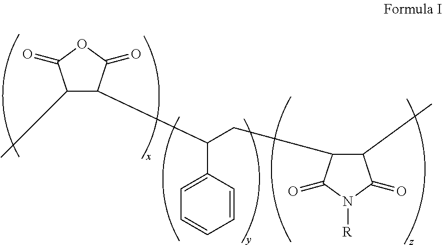

in which:
R is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R is an alkyl chain containing at least one primary, secondary, tertiary or quaternary amine function;
X, Y and Z represent the molar fraction of each of the monomer units, X is less than 0.1, Y is between 0.1 and 0.7 and Z is between 0.3 and 0.9, the sum X+Y+Z being equal to 1;
for the preparation of a cationic or non-ionic bituminous emulsion.

According to another aspect, a process is proposed for preparing a bituminous emulsion as described above, comprising a step of mixing a bituminous binder and an emulsifying composition as described above.

The features set out in the following paragraphs can, optionally, be implemented, independently of one another or in combination with one another:

### DETAILED DESCRIPTION

Emulsifying Composition

The invention therefore relates to an emulsifier composition comprising
a copolymer comprising between 10 mol % and 70 mol % of at least one monomer unit A and between 30 mol % and 90 mol % of at least one monomer unit B, the said monomer unit B being cationic or cationizable at acid pH,
and at least one emulsifier chosen from the group comprising cationic emulsifiers, non-ionic emulsifiers and amphoteric emulsifiers, and mixtures thereof.

For the purposes of this invention, the term cationizable refers to the property of a molecule of being able to carry one or more positive charges depending on its immediate environment. For example, a molecule carrying a primary, secondary or tertiary amine function may be non-ionic at a pH greater than or equal to the pKa of the amine function and cationic at a pH lower than its pKa, it being understood that the level of protonated amine functions increases as the pH decreases.

An emulsifying composition is a composition capable of forming an emulsion when mixed with another composition such as an oil or bitumen. In some cases, particularly for bitumen emulsions, the addition of shear energy may be necessary.

Copolymer

The copolymer of the emulsifier composition according to the invention is a random, alternating, block or grafted copolymer, preferably the copolymer is an alternating copolymer.

Advantageously, the copolymer has a weight-average molecular weight (Mw) between 500 and 100,000, more advantageously between 10,000 and 80,000 and even more advantageously between 30,000 and 60,000.

Advantageously, the monomer unit A is chosen from the group comprising, and more advantageously consisting of, olefins, diolefins, styrenes, vinyl esters, vinyl ethers, acrylates, methacrylates, acrylonitriles and their alkyl or aryl derivatives, adipic acid, benzoic acid, butyl benzoic acid, decadiene, ethylene, isobutene, iso-octylene, (meth)acrylic esters of saturated or unsaturated cyclic or bicyclic alcohols with 6 to 20 carbon atoms, (meth)acrylic esters, branched-chain alkyl alcohols, neopentyl glycol, octadecene, palmitic acid, pentaerythritol/neopentyl glycol, phthlatic anhydride, styrene, trimethylol ethane vinyl acetate or vinyl alkyl ethers and mixtures thereof. Particularly advantageously, the monomer unit A is styrene.

The molar percentage of monomer unit A, relative to the total number of monomer units in the copolymer, is comprised between 10% and 70%, preferably between 20% and 60%, more preferably between 45% and 65%, and even more preferably, the molar percentage of monomer unit A is 50%.

The monomeric unit B is cationic or cationizable. In the embodiment in which the monomeric unit B is cationic, said monomeric unit B advantageously comprises a quaternary ammonium. In the embodiment in which the monomeric unit B is cationizable, said monomeric unit B advantageously comprises a primary, secondary or tertiary amine functional group. In this embodiment, said amine function picks up a proton when the copolymer is placed in a medium whose pH is lower than the pKa of the said amine function, it being understood that the rate of protonated amine functions increases as the pH decreases.

The molar percentage of monomer unit B, relative to the total number of monomer units in the copolymer, is comprised between 30% and 90%, preferably between 40% and 70%, more preferably between 45% and 65%, and even more preferably, the molar percentage of monomer unit B is 50%.

In a particularly advantageous embodiment, the emulsifying composition according to the invention is characterized in that the copolymer is of formula I, in salified form or not;

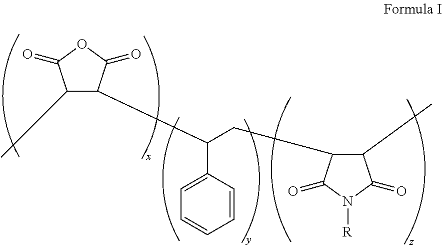

in which
R is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R is an alkyl chain containing at least one primary, secondary, tertiary or quaternary amine function;
X, Y and Z represent the molar fraction of each of the monomer units, X is less than 0.1, Y is comprised between 0.1 and 0.7 and Z is comprised between 0.3 and 0.9, the sum X+Y+Z being equal to 1.

Advantageously, R is selected from the group comprising, preferably consisting of, 2-ethylhexylamine, N-octylamine, decylamine, octadecylamine, stearylamine, laurylamine, N-methylstearin amine, N-ethyloctadecylamine, N-butyllaurylamine and mixtures thereof.

X is less than 0.5, advantageously X is less than 0.1 and even more advantageously X is equal to 0.

Y is comprised between 0.1 and 0.7, advantageously Y is comprised between 0.2 and 0.6, more advantageously Y is comprised between 0.35 and 0.55 and even more advantageously Y is equal to 0.5.

Z is comprised between 0.3 and 0.9, advantageously Z is comprised between 0.4 and 0.7, more advantageously Z is comprised between 0.45 and 0.65 and even more advantageously Z is equal to 0.5.

Emulsifier

The emulsifier composition according to the invention comprises at least one emulsifier chosen from the group comprising cationic emulsifiers, non-ionic emulsifiers and amphoteric emulsifiers and mixtures thereof, advantageously the emulsifier is chosen from the group comprising cationic emulsifiers and non-ionic emulsifiers, even more advantageously the emulsifier is a cationic emulsifier.

Advantageously, the emulsifying composition comprises between 0.5% and 2.5% by weight, relative to the total weight of the emulsion, of emulsifier.

Advantageously, the emulsifier composition comprises between 50% and 90% by weight, based on the total weight of the components other than water, of the copolymer of formula I, between 0.1% and 30% by weight, based on the total weight of the components other than water, of the nonionic emulsifier and between 0% and 5% by weight, based on the total weight of the components other than water, of the cationic and/or amphoteric emulsifier.

Advantageously, the emulsifiers have an HLB comprised between 10 and 30 according to the Griffin method of 1949.

Advantageously, the emulsifier comprises at least one amine, polyamine, amide, alkylamidoamine, alkylimidazoline, quaternary ammonium, ethylene oxide and propylene oxide function. Advantageously, the emulsifier comprises at least two different functions chosen from amine, polyamine, amide, alkylamidoamine, alkylimidazoline, quaternary ammonium, ethylene oxide and propylene oxide functions.

Advantageously, said emulsifier is chosen from fatty alkylimidazopolyamines, fatty alkylamidopolyamines, fatty polyamines, alkoxylated fatty polyamines, alkylated fatty polyamines and mixtures thereof, more advantageously, said emulsifier is chosen from mixtures of C16-C18 fatty alkylimidazopolyamines obtained by reacting fatty acids or vegetable oil with polyethylenepolyamines such as triethylenetetramine (TETA), tetraethylenepentamine (TEPA) and pentaethylenehexamine (PEHA) and ethoxylated tallow fatty polyamines.

Bituminous Emulsion

The invention also concerns a bituminous emulsion comprising a bituminous binder, the emulsifying composition as described above, and water, characterized in that the percentage by weight of the copolymer of the said emulsifying composition, relative to the total weight of the emulsion, is comprised between 0.75% and 3%, more advantageously between 0.9% and 2% and even more advantageously between 1% and 1.4%.

Advantageously, the bituminous emulsion has a percentage by weight of bituminous binder, relative to the total weight of the emulsion, comprised between 50% and 80%, preferably between 55% and 75% and more preferably between 60% and 70%.

Bituminous Binder

In the context of the present invention, bituminous binder is taken to mean all of the following products: natural bitumen, bitumen derived from mineral oil and mixtures resulting therefrom, bitumen obtained by atmospheric distillation, by distillation under reduced pressure, by visbreaking, by cracking, precipitation residues (such as in propane), blown bitumen, tars and mixtures that may result, synthetic or plant-based road binders containing modified or unmodified natural resins mixed with oils of petroleum or plant origin or their derivatives, and bitumen modified with natural or synthetic polymers. Examples of natural or synthetic polymers include, but are not limited to, thermoplastic elastomers such as statistical or block copolymers of styrene and butadiene, linear or star-shaped (SBR, SBS) or styrene and isoprene (SIS), possibly cross-linked, copolymers of ethylene and vinyl acetate, olefinic homopolymers and copolymers of ethylene, propylene or butylene, polyisobutylenes, polybutadienes, polyisoprenes, polyvinyl chloride, rubber powders or any polymer used for modifying bitumen and mixtures thereof. A quantity of polymer of 2 to 10% by weight relative to the weight of bitumen is generally used. These different polymers are considered without limitation of presentation, whether they are in anhydrous form (powder, granules or solution) or in the form of an aqueous dispersion (latex).

Some synthetic bitumen are also sometimes called clear, pigmentable or colorable bitumen. These bitumen contain little or no asphaltenes and can therefore be colored. These bitumen are based on petroleum resin and/or indene-coumarone resin and lubricating oil as described, for example, in patent EP 0 179 510.

Examples of common synthetic binders are Total's Kromatis® and/or Colas' Bituclair®.

Bituminous binders that can be used for the invention can also be mixtures of bitumen with hydrocarbon binders from industrial processes such as tall oil pitch (from the paper pulp refining process) or pitch from vegetable oil distillation processes. Such products, bituminous binders from refining or synthetic binders, can be used as they are or liquefied using a mineral or vegetable organic solvent, which may or may not be siccative, for example for use as a bonding primer, waterproofing coating or road bonding layer. According to another mode of use, they can be dispersed in an aqueous medium and thus give rise to hydrocarbon binders in aqueous phase. These binders, whether anhydrous or aqueous, can be used as they are or mixed with mineral materials, for example in the form of aggregates, such as sand, chippings, etc., to obtain bituminous road materials.

In one embodiment, the bitumen used are bitumen derived from the refining of crude oil, in particular from the atmospheric and/or vacuum distillation of crude oil. These bitumen may optionally be blown, visbreaked and/or deasphalted. The bitumen may be hard or soft grade bitumen. The different bitumen obtained by the refining processes can be combined to obtain the best technical compromise.

In another embodiment, the bitumen used are fluxed bitumen by adding volatile solvents, fluxing agents of petroleum origin, fluxing agents of coal origin and/or fluxing agents of vegetable origin.

Preferably, the bitumen according to the invention is chosen from unmodified crude oil refining bitumen, whether fluxed or not.

Additives

Generally speaking, for the preparation of bituminous road materials, the bitumen or binders used can be pure or modified with polymers. When polymers are used, they can be added to the bitumen so as to obtain bituminous products with improved mechanical properties. These polymer-modified bituminous products are used in road, urban and airport construction using, for example, the techniques mentioned above. Polymers are macromolecules formed by covalent chemical bonds between several repeating units or monomers. Bitumen modification with linear or branched polymers of high molar mass is used to improve the mechanical properties of the bituminous product. Bitumen modified in this way, known as polymer modified bitumen or PMB, are more flexible at low temperature and more plastic at high temperatures compared to their unmodified counterparts. They also have stronger internal cohesion. At last, PMB have a higher modulus of rigidity, which also improves resistance of bituminous materials to rutting or stripping of aggregates from coatings, for example.

The bitumen emulsion may also include one or more additives to further improve performance.

The bituminous emulsion according to the invention can advantageously be used to prepare a bituminous asphalt mix. A bituminous asphalt mix is a mixture between a bituminous binder and one or more granular materials, recycled or native such as chippings or sand. The bituminous emulsion according to the invention is particularly suitable for the preparation of a bituminous asphalt mix comprising between 5% and 12% by weight, relative to the total weight of the bituminous asphalt mix, of the bituminous emulsion and between 88% and 95% by weight, relative to the total weight of the bituminous asphalt mix, of granular materials.

### Other Aspects of the Invention

The invention also relates to the use of a copolymer of formula I, in salified for or not:

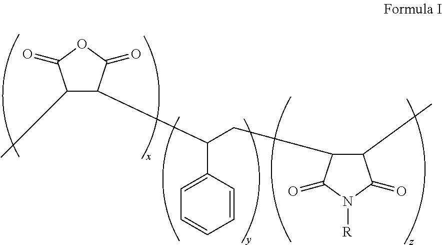

in which:
R is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R is an alkyl chain containing at least one primary, secondary, tertiary or quaternary amine function;
X, Y and Z represent the molar fraction of each of the monomer units, X is less than 0.1, Y is comprised between 0.1 and 0.7 and Z is comprised between 0.3 and 0.9, the sum X+Y+Z being equal to 1;
   for the preparation of a cationic or non-ionic bituminous emulsion.

The copolymer of formula I is advantageously obtained by reacting a copolymer of formula II

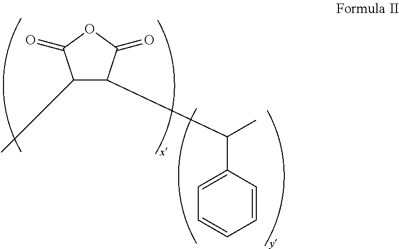

in which:
X′ and Y′ represent the molar fraction of each of the monomer units, X′ is comprised between 0.3 and 0.9 and Y′ is comprised between 0.1 and 0.7, the sum X′+Y being equal to 1;
   and an amine of formula III

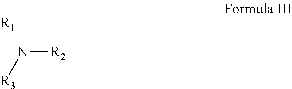

in which:
R₁ is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R₁ is an alkyl chain containing at least one primary, secondary, tertiary or quaternary amine function;
R₂ and R₃, which may be identical or different, are chosen from a hydrogen atom, a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R₂ and/or R₃ is an alkyl chain containing at least one primary, secondary, tertiary or quaternary amine function.

The invention also relates to a process for preparing a bituminous emulsion as described above, comprising a step of mixing a bituminous binder and an emulsifying composition as described above.

### Examples

### Preparation of Bitumen Emulsions EI1 to EI4, EC1 and EC2

The bitumen emulsions EI1 to EI4, according to the invention, and EC1 and EC2 (counter-examples) were obtained with a colloidal mill of the Emulbitume brand. The bitumen content by weight of the emulsion is 60%. The bitumen used is a paraffinic bitumen with a penetrability of 70/100 supplied by Total from the Feyzin refinery in France. The temperature of the bitumen during emulsification is 145° C. The bitumen was used fluxed with a petroleum fluxant.

The emulsions were prepared by introducing the aqueous phase emulsifying composition and the bituminous binder into a container. The compositions of the bituminous emulsions are listed in Table 1 below:

TABLE 1

| Components | EI1 | EI2 | EI3 | EI4 | EC1 | EC2 |
|---|---|---|---|---|---|---|
| Anhydrous phase: | | | | | | |
| Bitumen 70/100 (kg/t) | 582 | 582 | 582 | 582 | 582 | 582 |
| Fluxing agent (kg/t) | 18 | 18 | 18 | 18 | 18 | 18 |
| Aqueous phase: | | | | | | |
| CTA (kg/t) | — | — | — | — | — | 14 |
| CTI (kg/t) | 12.9 | 13 | 14 | 18 | 10.8 | — |
| including TI (kg/t) | 7.5 | 9.3 | 10 | 13.8 | 5.3 | — |
| HCl 33% (kg/t) | 2.5 | 2.5 | 2.5 | 2.5 | 2.5 | 2.5 |
| Water (kg/t) | 384.6 | 384.5 | 383.5 | 379.5 | 386.7 | 383.5 |

CTA: emulsifier: INDULIN GEF2 ®; CTI: emulsifier composition comprising XIRAN 1000IC ®, SERDOX NSP50 ® as a non-ionic emulsifier and DINORAM O ® as a cationic emulsifier; TI: XIRAN 1000IC ®.

Evaluation of Bitumen Emulsions

The emulsions are analyzed to determine their quality and application properties, in accordance with standard NE EN 13808 (August 2013).

The binder content of the emulsion is determined using the desiccant balance method (measured in accordance with standard NF EN 16849 of December 2016).

The quality of the emulsion is judged by the residue on a 0.5 mm sieve after manufacture (measured in accordance with standard NF EN 1429 of August 2013).

The quality of destabilization after application is judged using the breaking index measured with Q92 filler expressed in Forshamer according to the procedure described in standard NF EN 13075-1 of December 2016. The lower this index is, the faster the emulsion will tend to destabilize, leading to a more or less good coating quality.

The results are listed in Table 2 below:

TABLE 2

| | EI1 | EI2 | EI3 | EI4 | EC1 | EC2 |
|---|---|---|---|---|---|---|
| Penetrability of | 218 | 218 | 218 | 218 | 218 | 218 |
| the binder | | | | | | |
| (1/10 mm) | | | | | | |
| pH at 26° C.: | 2.5 | 2.6 | 2.6 | 2.5 | 2.1 | 2.6 |
| Dry extract: | | | | | | |
| IR - 110° C. (%) | 61.0 | 61.0 | 59.4 | 60.1 | 58.6 | 60.2 |
| Non-passing | <0.1 | <0.1 | <0.1 | <0.1 | <0.1 | <0.1 |
| sieve | | | | | | |
| 0.5 mm (%) | | | | | | |
| Breaking index | 181 | 189 | 199 | 221 | 210 | 183 |
| Forshamer | | | | | | |

All the emulsions tested comply with the specifications of standard NF EN 13808 of August 2013.

Qualification of Emulsions in the Gravel Emulsion Technique:

One of the normative criteria for qualifying the performance of cold mix techniques is the measurement of water sensitivity. This sensitivity measurement is codified in test standard NF P 98 251-4, Essai DURIEZ aménagé sur mélanges hydrocarbonés à froid à l'émulsion de bitume.

Cold mixes of the “Gravel Emulsion” type were formulated with the previous emulsions EI1 to EI4, EC1 and EC2, making sure to maintain a constant residual binder content in the mixes. The petrographic nature of the materials was analyzed: they are sericite schist from the CEYRAT quarry. The gravel emulsion formulas are given in table 3 below:

TABLE 3

| | GEI1 | GEI2 | GEI3 | GEI4 | GEC1 | GEC2 |
|---|---|---|---|---|---|---|
| GE 0/10 sericite schist: | | | | | | |
| Materials (%) | 100 | 100 | 100 | 100 | 100 | 100 |
| Emulsion (N° - ppc) | 7.2 | 7.2 | 7.2 | 7.2 | 7.2 | 7.2 |
| Total water (ppc) | 7 | 7 | 7 | 7 | 7 | 7 |

Standard EN 13108-31 defines the various performance criteria for bitumen emulsion mixes, as well as the performance classes. In this standard, a particular criterion related to the quality of the coating is specified on page 42 and reproduced in table 4 below.

TABLE 4

| | Minimum percentage |
|---|---|
| Coating class | of binder coverage % |
| C3 | >97 |
| C2 | 90 to 97 |
| C1 | 75 to <90 |
| C0 | <75 |

All the emulsions tested achieved a C3 coating level>97%.

These mixes were then subjected to the Duriez test in accordance with standard NF P 98 251-4. Standard NF P 98-121 defines the performance of bitumen emulsion asphalt mixes of the gravel emulsion type. Among other things, this standard specifies the application thicknesses of such materials, as well as the minimum characteristics to be achieved depending on the type of product formulated. In this standard, a summary table presents the minimum performances to be achieved in the Duriez test. The information in this table is reproduced in part in table 5 below.

TABLE 5

| | | Type S | Type S |
|---|---|---|---|
| Type of gravel emulsion | Type R | class 1 | class 2 |
| Compressive strength | ≥1.5 | ≥2.5 | ≥3.5 |
| without immersion | | | |
| (R in MPa) | | | |
| Ratio r/R | ≥55% | ≥55% | ≥65% |

The results obtained with the different gravel emulsions are shown in Table 6 below:

TABLE 6

| | GEI1 | GEI2 | GEI3 | GEI4 | GEC1 | GEC2 |
|---|---|---|---|---|---|---|
| GE 0/10 sericite schist: | | | | | | |
| r/R (%) | 55 | 61 | 60 | 77 | 33 | 33 |
| R (MPa) | 4.4 | 4.8 | 4.5 | 5.0 | 2.7 | 4.4 |
| Internal binder | 3.9 | 3.9 | 3.9 | 3.9 | 3.9 | 3.9 |
| content (%) | | | | | | |

These tests show that the higher the proportion of TI in the surfactant composition of the invention and therefore in the emulsion, the greater the water resistance of the asphalt mix.

In this way, the emulsifying composition according to the invention makes it possible to achieve the desired water resistance specifications without degrading the coating quality or the workability of the asphalt mix.

1. Emulsifier composition comprising:
a copolymer of formula I, in salified form or not: 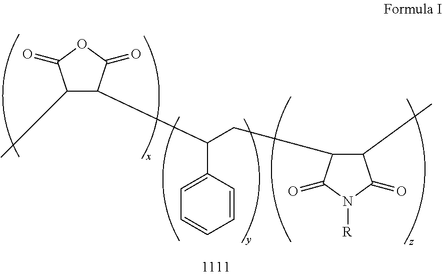
in which:
R is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R is an alkyl chain containing at least one primary, secondary, tertiary or quaternary amine function;
X, Y and Z represent the molar fraction of each of the monomer units, X is less than 0.1, Y is comprised between 0.1 and 0.7 and Z is comprised between 0.3 and 0.9, the sum X+Y+Z being equal to 1,
and at least one emulsifier chosen from the group comprising cationic emulsifiers, non-ionic emulsifiers and amphoteric emulsifiers and mixtures thereof.

2. Emulsifying composition according to claim 1, characterized in that R is chosen from the group comprising, preferably consisting of, 2-ethylhexylamine, N-octylamine, decylamine, octadecylamine, stearylamine, laurylamine, N-methylstearin amine, N-ethyloctadecylamine, N-butyllaurylamine and mixtures thereof.

3. Emulsifier composition according to claim 1, characterized in that the emulsifier is chosen from fatty alkylimidazopolyamines, fatty alkylamidopolyamines, fatty polyamines, alkoxylated fatty polyamines, alkylated fatty polyamines and mixtures thereof, more advantageously, the said emulsifier is chosen from mixtures of C16-C18 fatty alkylimidazopolyamines obtained by reacting fatty acids or vegetable oil with polyethylenepolyamines such as triethylenetetramine (TETA), tetraethylenepentamine (TEPA) and pentaethylenehexamine (PEHA) and ethoxylated tallow fatty polyamines.

4. Bituminous emulsion comprising a bituminous binder, the emulsifying composition according to claim 1 and water, characterized in that the percentage by weight of the copolymer of the said emulsifying composition, relative to the total weight of the emulsion, is comprised between 0.75% and 3%, more advantageously between 0.9% and 2% and even more advantageously between 1% and 1.4%.

5. Bituminous emulsion according to claim 4, characterized in that the percentage by weight of bituminous binder, relative to the total weight of the emulsion, is comprised between 50% and 80%.

6. Use of a copolymer of formula I, in salified form or not: 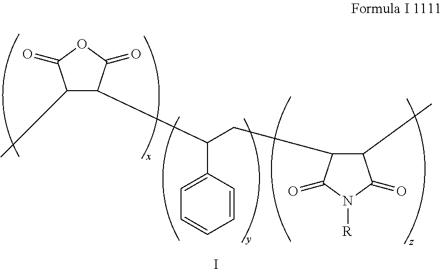
in which:
R is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R is an alkyl chain containing at least one primary, secondary, tertiary or quaternary amine function;
X, Y and Z represent the molar fraction of each of the monomer units, X is less than 0.1, Y is comprised between 0.1 and 0.7 and Z is comprised between 0.3 and 0.9, the sum X+Y+Z being equal to 1;
for the preparation of a cationic or non-ionic bituminous emulsion.

7. Use according to claim 6, characterized in that the copolymer is obtained by reacting a copolymer of formula II 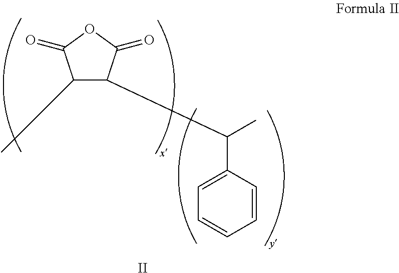
in which:
X′ and Y′ represent the molar fraction of each of the monomer units, X′ is comprised between 0.3 and 0.9 and Y′ is comprised between 0.1 and 0.7, the sum X′+Y′ being equal to 1;
and a primary amine of formula III 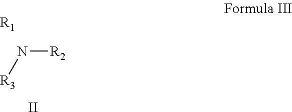
in which:
R₁ is a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R₁ is an alkyl chain containing at least one primary, secondary, tertiary or quaternary amine function;
R₂ and R₃, which may be identical or different, are chosen from a hydrogen atom, a linear or branched, saturated or unsaturated, aliphatic or aromatic monovalent hydrocarbon radical comprising at most 1000 carbon atoms, preferably between 5 and 25 carbon atoms, which may comprise one or more heteroatoms chosen from nitrogen and oxygen, preferably R₂ and/or R₃ is an alkyl chain containing at least one primary, secondary, tertiary or quaternary amine function.

8. A process for preparing a bituminous emulsion comprising a step of mixing a bituminous binder and the emulsifying composition according to claim 1, wherein a percentage by weight of the copolymer of the emulsifying composition, relative to the total weight of the bituminous emulsion is between 0.75% and 3%, more advantageously between 0.9% and 2% and even more advantageously between 1% and 1.4%.
